(19) United States
(12) Patent Application Publication
(10) Pub. No.: US 2006/0250917 A1
(43) Pub. Date: Nov. 9, 2006

(54) Method and device for transforming a first set of write parameters of a write strategy into a second set of write parameters at a different recording speed

(75) Inventors: Benno Tieke, Eindhoven (NL); Maarten Van Der Vleuten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/565,660

(22) PCT Filed: Jul. 16, 2004
(86) PCT No.: PCT/IB04/51245

§ 371 Date: Jan. 23, 2006

(30) Foreign Application Priority Data
Jul. 24, 2003 (EP) 03102278.3

(51) Int. Cl. G11B 7/0045

(52) U.S. Cl. 369/59.11

(57) ABSTRACT

The present invention relates to a method and a corresponding device for transforming a first set of write parameters (W) of a write strategy, in particular a 2T write strategy, for recording marks in an information layer (301) of a record carrier (30) by irradiating the information layer (301) with a pulsed radiation beam (32) at a first recording speed (R) into a second set of write parameters (W′) of said write strategy for recording marks at a second recording speed (R′), T representing the length of one period of a reference clock. In order to achieve an at least acceptable recording performance at the second recording speed, it is proposed according to the present invention that the duration of the write pulses is kept substantially constant in time, and the duration of a complete sequence of write pulses for recording a mark is kept substantially constant as a fraction of the reference clock T.

The present invention relates to a method and a corresponding device for transforming a first set of write parameters of a write strategy for recording marks in an information layer of a record carrier by irradiating the information layer with a pulsed radiation beam at a first recording speed into a second set of write parameters of said write strategy for recording marks at a second recording speed. The present invention further relates to a recording device for recording marks in an information layer of a record carrier by irradiating the information layer by means of a pulsed radiation beam, each mark being written by a sequence of one or more write pulses according to a write strategy.

The present invention is especially suitable for use with a record carrier comprising an information layer having a phase that is reversibly changeable between a crystal phase and an amorphous phase, generally known as a phase-change layer. Such a phase-change layer is often applied in optical record carriers of the rewritable type such as, for example, CD-RW and DVD-RW discs. A recording operation of optical signals is performed in such a manner that the recording material in the layer is reversibly changed in phase between an amorphous phase and a crystalline phase by changing the irradiation conditions of a radiation beam, so as to record the signals in the phase-change layer as a pattern of marks. A playback operation of the recorded signals is performed by detecting differences in optical properties between the amorphous and crystalline phases of the phase-change layer, so that the signals are reproduced. Such a phase-change layer allows information to be recorded and erased by modulation of the power of the radiation beam between a write power level, an erase power level, and a bias power level.

Recording speed is the main performance factor in optical recording. For CD-RW the basic standard is defined for the speed range 1× to 4× (1× being the standard scanning velocity of a CD Digital Audio disc of approx. 1.2 m/s), while the High-Speed CD-RW standard has a range from 4× to 10×. In September 2002, version 1.0 of the latest Ultra-Speed CD-RW standard was released defining CD-RW discs for speeds up to 24×, including also reservations for 32× and higher speeds (Recordable Compact Disc Systems, Part III: CD-RW, Volume 3: Ultra-Speed, Version 1.0, September 2002). To achieve these higher recording speeds, use has to be made of a so-called 2T write strategy as defined in the Ultra-Speed CD-RW standard. Therein, basically one write pulse is used for every two clock cycles of a reference clock (one clock cycle being indicated as T). This is done to obtain sufficient cooling times between two consecutive write pulses and thereby to avoid recrystallization, which is a problem especially with faster phase-change materials. A consequence of such a 2T write strategy is that consecutive even and odd marks are written with an identical number of write pulses, for example 3 pulses for both a 6T and a 7T mark.

A method and a recording device for recording marks in an information layer of an optical record carrier using a 2T write strategy have been described in European patent application 02 080 394.6 (PHNL021391EPP). The described method and recording device solve the problem of how to record marks in an information layer when no write parameter settings specifically tuned to the record carrier to be recorded are available for use in the 2T write strategy, or when the record carrier cannot be identified. Preferred settings for the write parameters of a 2T write strategy are proposed.

An important aspect of the 2T write strategy is the choice of the write parameters that define the difference between even and odd marks written with an identical number of write pulses. Even marks are generally recorded in a straightforward way by applying a pulse-train with a multi-pulse length Tₘₚ and a cooling gap T_{c}. To record a corresponding odd mark with a length of (length of even mark+1T), the pulse-train may be modified in three positions; an elongation of the penultimate gap (Δ_{1g}), of the last pulse (Δ₁ₚ), and of the last cooling gap (Δ₂), wherein Δ_{1g}=Δ₁ₚ=Δ₁ according to the Ultra-Speed CD-RW standard. Moreover, the shortest mark length I3 is defined by three special parameters, the pulse length T₃, the gap length T_{c3}, and the shift of the leading edge dT₃.

When implementing such a 2T write strategy it has been observed that the recording jitter is very sensitive to a large number of the write parameters. Consequently, these parameters have to be tuned very accurately. A problem is that the optimal parameter settings may be different for different recording speeds. Due to the limited rotation speed of the disc in the drive, the maximum recording speed is achieved at the outer radius of the disc; the recording speed on the inner part of the disc is normally lower. In the case of Ultra-Speed CD-RW, the maximum speed can be 24× or 32× (at present) or even higher (in the future), whereas at the inner part of the disc typically 16× (or 20×) recording speed is achieved. Thus, the recording speed is increased in a drive from the inside to the outside of the disc, for example in a constant angular velocity (CAV) mode, in a P-CAV mode (partial CAV mode) in which the first part is written in a CAV mode and the second part is written in a constant linear velocity (CLV) mode at the maximum recording speed of the disc, or in a Z-CLV mode (zoned CLV mode) in which the recording speed is increased in a number of discrete steps. Therefore, when the recording speed changes, new optimal sets of write parameters have to be determined for every recording speed.

It is therefore an object of the present invention to provide a method and a corresponding device for transforming a first set of write parameters of a write strategy, which are tuned to a first recording speed, into a second set of write parameters of said write strategy, which are tuned to a second recording speed, without reducing the recording performance or the quality of the recorded marks and while avoiding an increase of unwanted jitter as much as possible.

This object is achieved according to the present invention by providing a method as claimed in claim 1, wherein the duration of the write pulses is kept substantially constant in time, and the duration of a complete sequence of write pulses for recording a mark is kept substantially constant as a fraction of the reference clock.

A corresponding device that is adapted for carrying out the method is defined in claim 9, said device comprising input means for receiving a first set of write parameters and an information about said first and second recording speed, first transforming means for keeping the duration of the write pulses constant in time, second transforming means for keeping the duration of a complete sequence of write pulses for recording a mark constant as a fraction of the reference clock, and output means for outputting a second set of write parameters.

The present invention proposes a scheme for scaling write strategies for different recording speeds. If the parameter settings are known or predetermined at a given recording speed, they can be directly scaled to a different recording speed. The write performance at this target speed yields at least an acceptable recording performance. Adapting, in a further step, the recording power or other write parameters may of course further optimize the recording performance.

The present invention is based on the idea of distinguishing two fundamental classes of write parameters. One class of write parameters is related to the individual write pulses, the other class is related to the duration of the complete pulse train for a certain effect length. The relevant time scale for the first class, that is the write pulses, is an absolute time scale (i.e. in ns). The write parameter settings belonging to this category are kept constant in absolute time for the different recording speeds. In other words, write parameters of this category are changing on a relative time scale (duty cycle) when the recording speed is changed. The relevant time scale for the write parameters not directly related to the write pulses is a relative time scale (i.e. relative to the reference clock). These parameters are kept constant as a fraction of the reference clock when the recording speed is changed.

The absolute time scale is important for the write pulses because it defines the energy dissipated in the information layer of the disc, and thus the temperature profile. It has to be realized that the displacement of the optical spot during a write pulse is much smaller than the optical spot size, even at high speeds. Therefore, a write pulse of a certain absolute duration will typically melt the same area in the information layer of the disc, regardless of the recording speed. Keeping all write pulses constant in time will achieve a similar recording result at all recording speeds, applying typically the same write power.

Embodiments of the invention are defined in the dependent claims. In an embodiment it is proposed that an even mark having a time length of nT, where n represents an integer value equal to 4, 6, 8 or 10 and T represents the length of one period of the reference clock, is written by a sequence of n/2 write pulses, whereas an odd mark having a time length of nT, where n represents an integer value equal to 5, 7, 9 or 11, is written by a sequence of (n−1)/2 write pulses, and that a mark having a time length of 3T is written by a single write pulse.

Thus, a 2T write strategy as defined in the Ultra-Speed CD-RW standard is employed according to the present invention. However, it should be noted that the present invention can generally be applied to other 2T write strategies, 1T write strategies or even mT write strategies (where m is larger than 2) as well. The speed scaling for a 2T write strategy is difficult because there are two series of runlengths, i.e. odd effects and even effects. The problem is that there is always an odd effect that is written with the same number of write pulses as a corresponding even effect; for example, 4T and 5T marks are both written with two write pulses. Now, the 2T write strategy must be tuned to give as a result either a 4T or a 5T mark. However, as soon as some recording parameters change, for example the recording speed, the resulting mark lengths may behave differently for odd and even marks. In the case of a 1T write strategy this problem is less dramatic; the marks are written with (n−1) write pulses, therefore there are never two marks written with an identical number of write pulses.

According to a further embodiment it is proposed that a last write pulse in the sequence of write pulses for writing an odd mark is a period Δ₁ longer than a last write pulse in the sequence of write pulses for writing an even mark, and a gap preceding the last write pulse in the sequence of write pulses for writing an odd mark is a period Δ₁ longer than a gap preceding the last write pulse in the sequence of write pulses for writing an even mark.

It is thus preferred that the period Δ₁ is kept constant in time when the second set of write parameters for a second recording speed is determined. Preferably, said period Δ₁ is within a range from 1 to 5 ns, in particular within a range from 2 to 4 ns. An exemplary value for Δ₁ is 3.6 ns. If too small a value for Δ₁ is used, the cooling gaps of the odd marks have to be made much longer than the cooling gaps of the even marks because the 1T difference has to be put somewhere in the pulse train of the write pulses. As a result the effect shapes are really different, which increases jitters. If too high a value for Δ₁ is used, the last odd mark will be relatively long, which causes recrystallization since the cooling is not good enough to deal with the increased energy, resulting again in higher jitters.

Preferred ranges for the write parameters to be kept constant in time, and preferred substantial values for these parameters are defined in claim 5.

According to a further embodiment of the invention, a mark having a time length of 3T is written by a single write pulse having a time length T3′−dT₃, the start of which is delayed by a period of dT₃ relative to the start of write pulses for writing an even or odd mark, and which is a period of Δ₃−dT₃ longer than the write pulses for writing an even mark. When the write pulse for writing a 3T mark is prolonged by a time period Δ₃ having a fixed time duration with respect to the duration of a single write pulse, a good sequence for writing a 3T mark is obtained. It should be noted that dT3, as defined in the above-mentioned Ultra-Speed CD-RW standard, may have a positive or a negative value. It is defined as a delay in the Ultra-Speed CD-RW standard.

Parameters defining the length of the complete write pulse train for a certain mark length are defined as a fraction of the reference clock. The preferred choice is to define the parameters Θₑᵥₑₙ, Θ_{odd} and Θ₃ as the beginning of the erase pulse at the end of a write pulse sequence relative to the nominal write pulse; that is, for a mark of length nT the erase power level starts (n−Θ)T after the beginning of the mark.

According to another embodiment of the invention it is thus proposed that the duration of a complete sequence of write pulses for writing a mark having a time length of nT, where n represents an integer value equal to 4, 6, 8 or 10, is equal to (n−Θₑᵥₑₙ)T, the duration of a complete sequence of write pulses for recording a mark having a time length of nT, where n represents an integer value equal to 5, 7, 9 or 11, is equal to (n−Θ_{odd})T, and the duration of the single write pulse and the subsequent cooling gap for recording a mark having a time length of 3T is equal to (3−Θ₃)T, wherein said values of Θₑᵥₑₙ, Θ_{odd}, and Θ₃ are kept constant as a fraction of the reference clock T.

The reason for introducing this new set of Θ-parameters is that a certain mark length will always be written with a certain pulse train length, such as an I6 mark which will always be written with a pulse train of about 6T length. This basic rule holds in fact at any recording speed. Therefore, it can be expected that the related Θ-parameters are not changed substantially when the recording speed is changed. It should be noted that the Θ-parameters are strongly coupled. In general the differences between the Θ-parameters should be very small, preferably smaller than 2/8T.

Preferred ranges and preferred substantial values for the Θ-parameters are defined in claim 8. It should be noted that these parameters are dependent on other parameters, such as the time length of a normal write pulse and the period Δ₁.

The present invention is preferably applied in a recording device comprising a radiation source for providing the radiation beam, a control unit operative in controlling the power of the radiation beam and in providing the sequences of pulses for recording the marks, a selection unit operative in selecting and/or controlling the recording speed, and a transformation device for transforming a first set of write parameters of a 2T write strategy for recording marks at a first recording speed into a second set of write parameters of said 2T write strategy for recording marks at a second recording speed according to the method as claimed in claim 1.

This means that during operation a new set of write parameters can be determined (almost) in real-time when the recording speed is changed, for example when at first data is recorded at the inner side of a disc and subsequently data is recorded at the outer side of a disc. This may be used to advantage, for example, when data is recorded in a constant angular velocity mode or in a partial constant angular velocity mode, where the inner part of the disc is recorded in a constant angular velocity mode and the outer part of the disc is recorded in a constant linear velocity mode, as is most often used by present day drives.

According to another embodiment the recording device further comprises a storage means for storing at least two sets of write parameter settings for recording marks at different recording speeds, wherein said transformation device is further operative in selecting the corresponding set of write parameters from said storage means according to the selected recording speed. It is thus possible that two or more sets of write parameters for different recording speeds are determined in advance, for example the recording speeds typically used by the recording device during recording, and that during operation the appropriate write parameters settings are selected in accordance with the applied recording speed.

The transformation of the write parameters can thus be done in the drive itself during or before the recording of data, for example when a new disc for recording of data is inserted, or alternatively by the manufacturer of the drive, who then stores the different sets of write parameters in the recording device, for example in a look-up table. Thus, the invention can be used for (almost) real-time scaling in the device itself, or for scaling during drive development.

The invention will now be explained in more detail with reference to the accompanying drawings in which

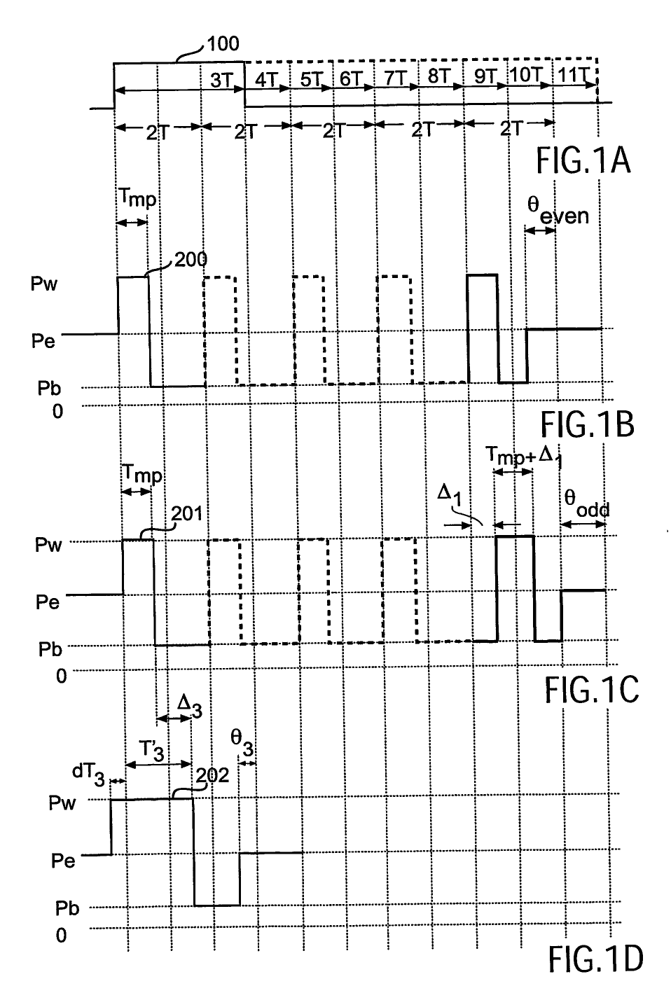

FIGS. 1A-1D show diagrams of the time dependency of a digital data signal and of control signals for controlling the power of the radiation beam for recording marks according to the present invention,

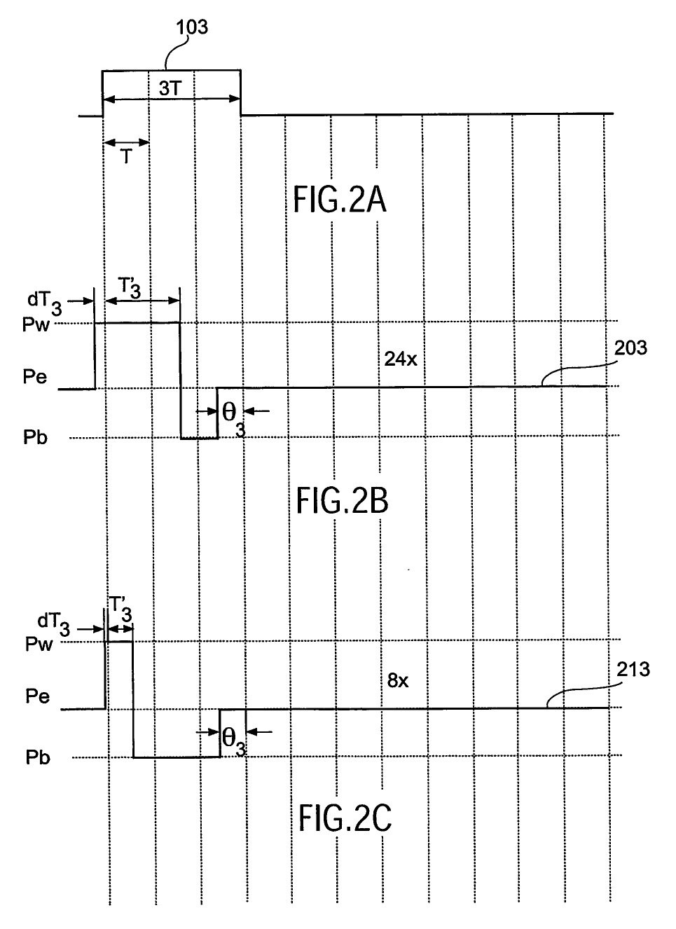

FIGS. 2A-2C show diagrams of the time dependency of a digital data signal and of control signals for controlling the power of the radiation beam for recording a 3T mark,

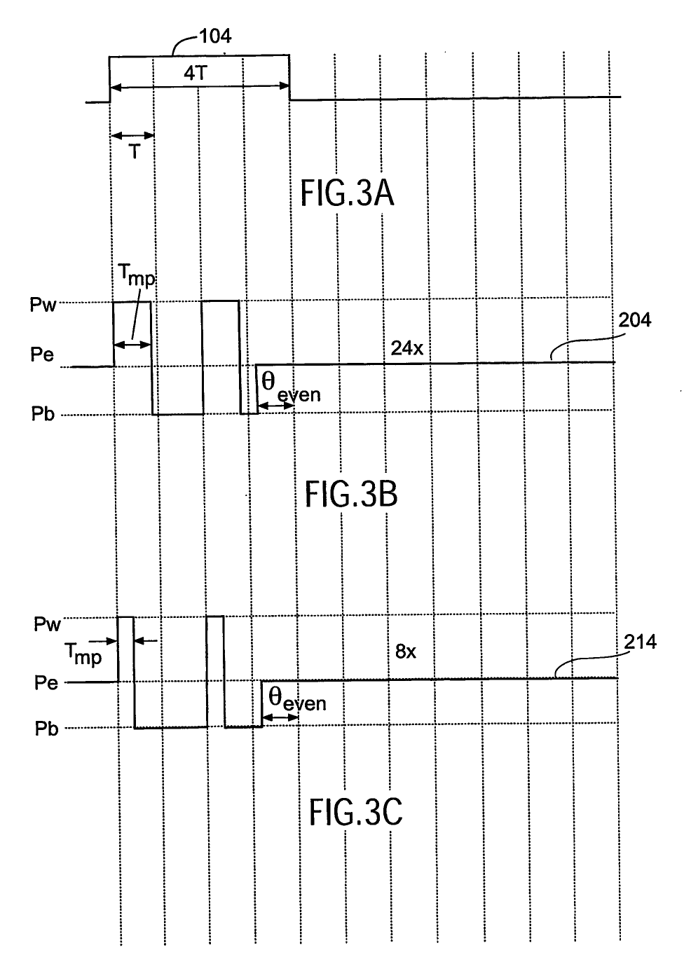

FIGS. 3A-3C show diagrams of the time dependency of a digital data signal and of control signals for controlling the power of the radiation beam for recording a 4T mark,

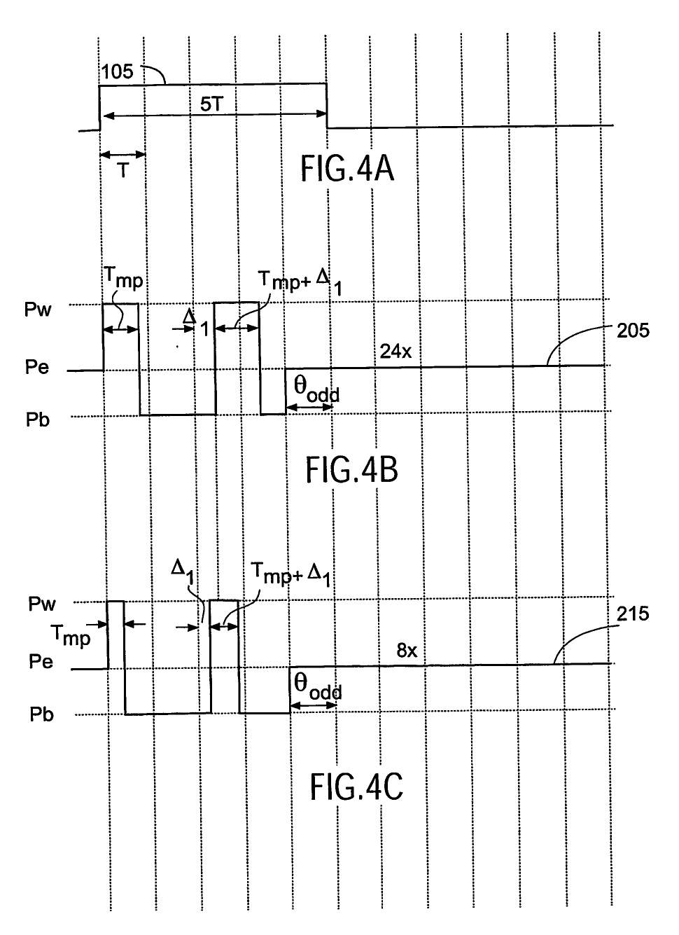

FIGS. 4A-4C show diagrams of the time dependency of a digital data signal and of control signals for controlling the power of the radiation beam for recording a 5T mark, and

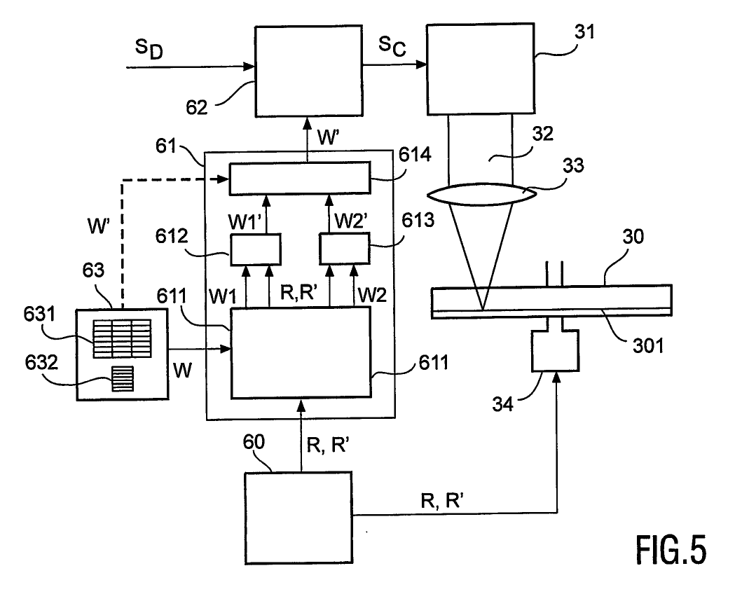

FIG. 5 shows a block diagram of a recording device according to the present invention.

FIG. 1A shows a digital data signal 100 as a function of time. The values of this digital data signal 100 represent the lengths of marks to be recorded in the information layer of a record carrier. The vertical dotted lines indicate transitions in a reference clock signal belonging to the data signal 100. T indicates one period of this reference clock, also called the channel bit period. The digital data signal 100 represents marks to be recorded in the range from 3T to 11T, that is marks having a length substantially equal to the duration of 3 to 11 periods of the reference clock times the recording speed.

FIG. 1B shows the corresponding control signals 200 for recording the even marks, that is the 4T, 6T, 8T and 10T marks, while FIG. 1C shows the corresponding control signals 201 for recording the odd marks, that is the 5T, 7T, 9T and 11T marks. FIG. 1D shows the control signal 202 for recording the 3T mark.

The control signals are used to control the power of the radiation beam, where it is assumed that the power of the radiation beam is proportional to the corresponding level of the control signal. A mark is recorded by a sequence of pulses having a write power level Pw and having a bias power level Pb in between the pulses. Previously recorded marks between the marks being recorded are erased by applying an erase power level Pe.

Since a 2T write strategy is used, the even marks having a time length of nT are recorded by a sequence of n/2 pulses, and the odd marks having a time length of nT are recorded by a sequence of (n−1)/2 pulses. This results in a 4T even mark and a 5T odd mark being recorded by a sequence of 2 pulses, a 6T even mark and a 7T odd mark being recorded by a sequence of 3 pulses, a 5T even mark and a 9T odd mark being recorded by a sequence of 4 pulses, and a 10T even mark and a 11T odd mark being recorded by a sequence of 5 pulses, as is indicated by the dashed lines in FIGS. 1B and 1C. To obtain recorded marks of good quality (that is, having a jitter within the prescribed range) for both the even marks and the odd marks, the sequence of pulses for recording the odd marks are adjusted such that the last pulse in the sequence of pulses for writing an odd mark is a period Δ1 longer than a last pulse in the sequence of pulses for writing an even mark having a duration Tₘₚ, and a gap preceding the last pulse in the sequence of pulses for writing an odd mark is a period Δ1 longer than a gap preceding the last pulse in the sequence of pulses for writing an even mark.

Furthermore, parameters defining the length of the complete pulse train for a certain mark length are defined. A parameter Θₑᵥₑₙ is defined for control signal 200 for writing even marks, and a parameter Θ_{odd} is defined for control signal 201 for recording odd marks, both being defined as the beginning of the erase power level following the pulse train relative to the nominal mark length, that is, for a mark of length nT, the erase power level Pe starts (n−Θ)T after the beginning of the mark.

FIG. 1D shows a control signal 202 for recording a 3T mark. The 3T mark is written by a single pulse, the start of which is delayed by a period of dT₃ (dT₃ being negative in this case) relative to the start of the write pulses for writing an even or odd mark and which is a period of Δ₃−dT₃ longer than the write pulses for writing an even mark. For control signal 202, a parameter Θ₃ is defined as the beginning of the erase power level Pe following the write pulse relative to the nominal mark length, that is, for the 3T mark the erase power level Pe starts (3−Θ₃)T after the beginning of the 3T mark.

FIG. 2A shows a digital data signal 103 to be recorded as a 3T mark. FIG. 2B shows a control signal 203 relating to the digital data signal 103 which is adapted for recording marks in the information layer at 24× recording speed, that is a recording speed 24 times faster than the speed used for reproducing data according to the CD-Audio standard (1×), where one period T of the reference clock is approx. 231 ns. Similarly, FIG. 2C shows a control signal 213 relating to the digital data signal 103 which is adapted for recording marks in the information layer at 8× recording speed. Taking into account that T=9.6 ns for 24× and T=28.8 ns for 8×, it can be seen that the duration of the single write pulse, i.e. T′₃−dT₃, is kept constant in time, for example dT₃=0.5 ns and T′₃=13 ns. Furthermore, it can be seen that the parameter Θ₃ is kept constant as a fraction of the reference clock T, for example Θ₃=⅞ T which is 8.4 ns for 24× and 25.2 ns for 8×.

FIG. 3A shows a digital data signal 104 to be recorded as a 4T mark. FIG. 3B shows a control signal 204 relating to the digital data signal 104 which is adapted for recording marks in the information layer at 24× recording speed. Similarly, FIG. 3C shows a control signal 214 relating to the digital data signal 104 which is adapted for recording marks in the information layer at 8× recording speed. It can be seen that the duration of the write pulses, i.e. Tₘₚ, is kept constant in time, for example Tₘₚ=7.2 ns. Furthermore, it can be seen that the parameter Θₑᵥₑₙ is kept constant as a fraction of the reference clock T, for example Θₑᵥₑₙ=⅞ T which is 8.4 ns for 24× and 25.2 ns for 8×.

FIG. 4A shows a digital data signal 105 to be recorded as a 5T mark. FIG. 4B shows a control signal 205 relating to the digital data signal 105 which is adapted for recording marks in the information layer at 24× recording speed. Similarly, FIG. 4C shows a control signal 215 relating to the digital data signal 105 which is adapted for recording marks in the information layer at 8× recording speed. It can be seen that the duration of the write pulses, i.e. Tₘₚ and Tₘₚ+Δ₁ respectively, are kept constant in time, for example Tₘₚ=7.2 ns and Δ₁=3.6 ns. Furthermore, it can be seen that the parameter Θ_{odd} is kept constant as a fraction of the reference clock T, for example Θ_{odd}= 8/8 T which is 9.6 ns for 24× and 28.8 ns for 8×.

FIG. 5 shows an embodiment of a recording device according to the present invention for recording marks in an information layer 301 of a disc-shaped record carrier 30. The information layer 301 is of the so-called phase-change type, that is, it has a phase that is reversibly changeable between a crystal phase and an amorphous phase. The record carrier is rotated about its center by a motor 34. A radiation beam 32 is generated by a radiation source 31 such as, for example, a laser light source, and focused onto the information layer 301 by a lens 33.

The power of the radiation beam 32 is controlled by a control signal S_{C} provided by a control unit 62, where it is assumed that the power of the radiation beam 32 is proportional to the corresponding level of the control signal S_{C}. Examples of such a control signal S_{C} have been shown in FIGS. 1B-1D, 2B-2C, 3B-3C, and 4B-4C. The control unit 62 converts a digital data signal S_{D} representing the length of a mark to be recorded in the information layer 301 of the record carrier 30 into a corresponding control signal S_{C}. This conversion is based on a so-called write strategy, which is a 2T write strategy according to the present invention. Examples of such digital data signals S_{d} are shown in FIGS. 1A, 2A, 3A and 4A.

The patterns of the pulses and the gaps between the pulses in the control signal S_{C} are based on a set of write parameters W1′, W2′ related to the applied 2T write strategy. These write parameters W1′, W2′ are provided to the control unit 62 by an output unit 614 of a transformation device 61. In this set of write parameters, the first subset W1′ indicates write parameters which are kept constant in time when they are determined by a first transformation unit 612 from the corresponding subset of write parameters W1 (adapted to a first, e.g. default, recording speed R) according to a new recording speed R′. The second subset W2′ indicates write parameters which are constant as a fraction of the reference clock T when they are determined from the corresponding previous subset of write parameters W2 (adapted to said first, e.g. default, recording speed R) by a second transformation unit 613 according to the new recording speed R′.

The information regarding the initial (first) recording speed R and the new (second) recording speed R′ is received by input means 611 of the transformation device from a selection unit 60 which is adapted for selection and/or control of the recording speed of the motor 34. The selection and/or control of the recording speed is based, for example, on an identification of the record carrier 31, which identification may be based, for example, on a media identifier stored on the record carrier 30. The selection unit 60 may be further adapted for control of the recording speed according to a constant angular velocity mode, a partial constant angular velocity mode, or a zoned constant linear velocity mode, the recording speed being adapted to the position on the information layer 301 where data is to be recorded. Thus, the recording speed can be continuously modified during recording or can be modified in steps if particular recording speeds are assigned to particular areas on the medium 30.

A first, or default, set of write parameters W comprising the subsets W1, W2 is further obtained by the input unit 611 from a storage unit 63. This storage unit 63 stores at least one set of write parameters adapted for a particular recording speed in a default storage unit 632. All other sets of write parameters for different recording speeds are determined by the transformation device 61 from this default set of write parameters. This determination preferably takes place online and in real-time when the recording speed is changed by the selection unit 60. This means that these sets of write parameters are determined by the recording device just before actual recording is performed, based on the recording mode to be applied or based on an identification of the recording speeds which will be applied for recording data on this particular record carrier 30.

However, it is alternatively possible that different sets of write parameters for different recording speeds are stored in a look-up table 631, so that in response to a change in recording speed the appropriate set of write parameters W′ is selected from this look-up table 631 and immediately provided to the control unit 62 by the output means 614 of the transformation device 61 without the need for any transformation. The different sets of write parameters stored in the look-up table 631 can thus be provided by the manufacturer of the recording device, who preferably determines these sets of write parameters using a similar or same transformation device 61.

To scale write strategies to different recording speeds, a basic set of write parameters is required to start from. A good starting point is, for example, the default set of write parameters at 16× recording speed such as, for example, the set of write parameters described in European patent application 02080394.6 (PHNL021391EPP). This set of write parameters may also serve as a starting point in an actual drive because the maximum speed at the inner radius is typically 16× for CD-RW. These write parameters can be scaled to 24× and 8×, respectively.

Using this starting point it has been found that at 16× the mark and space lengths are well distributed and within the specified range and that all space and all mark data-to-data jitters (standard deviation of a certain mark length measured in time domain/length of one clock period T) are low, typically 9%. The write power used is 36 mW, as an example. This relates to all effect lengths, i.e. to the recording of 3T to 11T marks.

To obtain the set of write parameters for 24× in a first step, the 16× write parameters are directly scaled as described above, that is, the pulse type parameters (Tₘₚ, T_{3′}, dT3, Δ₁) are kept constant in time and the theta parameters (Θ_{odd}, Θₑᵥₑₙ, Θ₃) are kept constant as a fraction of the clock. Furthermore, the same writing power as at 16× is used. The mark jitters remain low (typically 9%) and also the mark length distribution is acceptable. The space jitter is slightly increased to 11-12%, which is still within the specified range of 15%. Thus, the write performance after direct scaling to 24× without any parameter changes yields a good writing performance. Optionally, in a second step, the performance can be further improved by adjusting the write power or the write parameters in a fine tuning operation which will not be described in more detail here.

A typical scaling application is to scale to a higher speed as described above. In some cases a scaling to lower speed may also be useful, for example when the write performance at a certain speed is not acceptable and recording at lower speed might yield acceptable results. As an example, the 16× write parameters may be scaled to 8× write parameters. Without any parameter and write power changes, the resulting recording performance was found to be excellent.

Typical write parameters used for 8×, 16× and 24× are listed in the following Table:

W

| | 16x | 24x | 8x |
|---|---|---|---|
| Tₘₚ | 4/8 T = 7.2 ns | 6/8 T = 7.2 ns | 4/16 T = 7.2 ns |
| T₃′ | 7/8 T = 12.6 ns | 11/8 T = 13.2 ns | 7/16 T = 12.6 ns |
| | | (12.6 ns) | |
| dT₃ | 0/8 T = 0.0 ns | 0/8 T = 0.0 ns | 0/16 T = 0.0 ns |
| Δ₁ | 2/8 T = 3.6 ns | 3/8 T = 3.6 ns | 2/16 T = 3.6 ns |
| Θ₃ | 7/8 T = 12.6 ns | 7/8 T = 8.4 ns | 7/8 T = 12.6 ns |
| Θₑᵥₑₙ | 7/8 T = 12.6 ns | 7/8 T = 8.4 ns | 7/8 T = 12.6 ns |
| Θ_{odd} | 8/8 T = 14.4 ns | 8/8 T = 9.6 ns | 8/8 T = 14.4 ns |

In this Table, the write parameters for 24× and 8× are obtained from the write parameters at 16×. Values indicated by bold numbers are kept constant on an absolute or relative time scale, respectively. This experiment was done from 16×, 24×, and 8×, because 16× is exactly between 8× and 24×. Scaling to either lower or higher recording speeds can be useful in practice, especially in a drive development environment. Furthermore, 8× is also a practically important speed since drives in laptops usually start at 8× at the inner radius of the disc.

The parameters described above are a suitable set for understanding the physics of the recording process. For a practical application, write parameters as defined in the Ultra-Speed CD-RW standard are often preferred. The relations between the write parameters described above and the write parameters as defined in the standard are:

| Standard | Present invention |
|---|---|
| Tₘₚ | Tₘₚ |
| T₃ | T₃′ − dT₃ |
| dT₃ | dT₃ |
| Δ₁ | Δ₁ |
| T_{c} | 2 − Tₘₚ − Θₑᵥₑₙ |
| T_{c3} | 3 − T₃′ − Θ₃ |
| Δ₂ | 1 − 2Δ₁ − Θ_{odd} + Θₑᵥₑₙ |

In general, write parameters are implemented in a drive as subdivisions of the write clock T. This is the natural choice for the relative time scale, thus the scaling of these parameters is straightforward. However, the write parameters scaled on the basis of the absolute time scale may need to be matched to the subdivision available in a specific device.

1. Method of transforming a first set of write parameters (W) of a write strategy for recording marks in an information layer (301) of a record carrier (30) by irradiating the information layer (301) with a pulsed radiation beam (32) at a first recording speed (R) into a second set of write parameters (W′) of said write strategy for recording marks at a second recording speed (R′), wherein the duration of the write pulses is kept substantially constant in time, and the duration of a complete sequence of write pulses for recording a mark is kept substantially constant as a fraction of a reference clock.

2. Method according to claim 1, wherein
an even mark having a time length of nT, where n represents an integer value equal to 4, 6, 8 or 10, and T represents the length of one period of the reference clock, is written by a sequence of n/2 write pulses,
an odd mark having a time length of nT, where n represents an integer value equal to 5, 7, 9 or 11, is written by a sequence of (n−1)/2 write pulses, and
a mark having a time length of 3T is written by a single write pulse.

3. Method according to claim 2, wherein
a last write pulse in the sequence of write pulses for writing an odd mark is a period Δ₁ longer than a last write pulse in the sequence of write pulses for writing an even mark, and a gap preceding the last write pulse in the sequence of write pulses for writing an odd mark is a period Δ₁ longer than a gap preceding the last write pulse in the sequence of write pulses for writing an even mark.

4. Method according to claim 3,
wherein said period Δ₁ is kept constant in time and is within a range from 1 to 5 ns, in particular within a range from 2 to 4 ns.

5. Method as claimed in claim 3, wherein
the duration of the write pulses, except for the last pulse for writing an odd mark and except for the write pulse for writing a mark having a time length of 3T, is in a range from 5 to 10 ns, in particular substantially equal to 7.2 ns,
the period Δ₁ has a duration in a range from 2 to 5 ns, in particular substantially equal to 3.6 ns,
and the duration of the single write pulse for writing a mark having a time length of 3T is in a range from 8 to 15 ns, in particular substantially equal to 12.6 ns.

6. Method according to claim 1,
wherein a mark having a time length of 3T, T representing the length of one period of the reference clock, is written by a single write pulse having a time length T3′−dT₃, the start of which is delayed by a period of dT₃ relative to the start of write pulses for writing an even or odd mark, and which is a period of Δ₃−dT₃ longer than the write pulses for writing an even mark.

7. Method as claimed in claim 1, wherein
the duration of a complete sequence of write pulses for writing a mark having a time length of nT, where n represents an integer value equal to 4, 6, 8 or 10, and T represents the length of one period of the reference clock, is equal to (n−Θₑᵥₑₙ)T,
the duration of a complete sequence of write pulses for recording a mark having a time length of nT, where n represents an integer value equal to 5, 7, 9 or 11, is equal to (n−Θ_{odd})T,
and the duration of the single write pulse and the subsequent cooling gap for recording a mark having a time length of 3T is equal to (3−Θ₃)T,
and wherein said values of Θₑᵥₑₙ, Θ_{odd} and Θ₃ are kept constant as a fraction of the reference clock T.

8. Method according to claim 7, wherein
Θₑᵥₑₙ is in a range from ⅝ T to 9/8T, in particular substantially equal to ⅞T,
Θ_{odd} is in a range from 6/8T to 10/8T, in particular substantially equal to 8/8T,
and Θ₃ is in a range from ⅝T to 9/8T, in particular substantially equal to ⅞T.

9. Device for transforming a first set of write parameters (W) of a write strategy for recording marks in an information layer (301) of a record carrier (30) by irradiating the information layer (301) with a pulsed radiation beam (32) at a first recording speed (R) into a second set of write parameters (W′) of said write strategy for recording marks at a second recording speed (R′), said device comprising:
input means (611) for receiving said first set of write parameters and an information about said first and second recording speeds (R, R′),
first transforming means (612) for keeping the duration of the write pulses constant in time, second transforming means (613) for keeping the duration of a complete sequence of write pulses for recording a mark constant as a fraction of a reference clock,
and output means (614) for outputting said second set of write parameters (W′).

10. Recording device for recording marks in an information layer (301) of a record carrier (30) using a write strategy by irradiating the information layer (301) by means of a pulsed radiation beam (32), each mark being written by a sequence of one or more write pulses, said recording device comprising:
a radiation source (31) for providing the radiation beam (32),
a control unit (62) operative in controlling the power of the radiation beam (32) and in providing the sequences of pulses for recording the marks,
a selection unit (60) operative in selecting and/or controlling the recording speed (R, R′),
and a transformation device (61) for transforming a first set of write parameters (W) of a write strategy for recording marks at a first recording speed (R) into a second set of write parameters (W′) of said write strategy for recording marks at a second recording speed (R′) according to claim 1.

11. Recording device as claimed in claim 10, wherein
said selection unit (60) is adapted for controlling the recording speed (R, R′) in accordance with a constant angular velocity operation, a partial constant angular velocity operation, or a zoned constant linear velocity operation.

12. Recording device as claimed in claim 10,
further comprising a storage means (63) for storing at least two sets of write parameter settings for recording marks at different recording speeds (R, R′), said transformation device (61) being further operative in selecting the corresponding set of write parameter settings (W) from said storage means (63) in accordance with to the selected recording speed (R, R′).
